(19) United States
(12) Patent Application Publication
(10) Pub. No.: US 2013/0042680 A1
(43) Pub. Date: Feb. 21, 2013

(54) APPARATUS FOR MEASURING GRAVITATIONAL FORCE AND METHODS OF USING THE SAME

(71) Applicants: Chee Wei Wong, Weehauken, NJ (US); Ying Li, New York, NY (US); Jianjung Zheng, New York, NY (US); Daniel Rogers, Baltimore, MD (US)

(72) Inventors: Chee Wei Wong, Weehauken, NJ (US); Ying Li, New York, NY (US); Jianjung Zheng, New York, NY (US); Daniel Rogers, Baltimore, MD (US)

(21) Appl. No.: 13/587,689

(22) Filed: Aug. 16, 2012

Related U.S. Application Data
(60) Provisional application No. 61/524,055, filed on Aug. 16, 2011.

(51) Int. Cl. G01V 7/02

(52) U.S. Cl. 73/382 R

(57) ABSTRACT

An apparatus for measuring gravitational force is provided having at least one optomechanical oscillator, the at least one optomechanical oscillator having an initial resonance, and a second resonance when displaced by gravitational force; and at least one photonic crystal having at least one cavity coupling optical and mechanical degrees of freedom of the oscillator.

### CROSS-REFERENCE TO RELATED APPLICATIONS

This application claims priority to U.S. Provisional Application 61/524,055 filed Aug. 16, 2011, and which is incorporated by reference in its entirety herein.

### FIELD OF THE DISCLOSED SUBJECT MATTER

Exemplary embodiments of the present disclosure generally relate to gravimeters, and more specifically to exemplary chip-scale high-performance gravimeters having cavity optomechanics.

### BACKGROUND

There are generally three main classes of gravimeters: (a) laser or atom interferometers using timed measurements, (b) cryogenic superconducting levitated masses, and (c) spring-type gravimeters.

Laser interferometers have been implemented commonly for precision metrology across many scales and allow absolute gravimetry measurements with 1 to 10 μGal accuracies. Typically, laser interferometers involve timed and multiple-sampled measurements with calibrated or stabilized lasers, including locked to atomic clocks, to measure the free-fall of a reflecting body. Recent advances, for example, have used cold atom interferometry to determine the gravitational redshift to an accuracy of 7×10⁻⁹, improved precision of the gravitational constant to 1×10⁻⁴, or the gravity to a sensitivity of 100 ng per shot. With the interferometric or timed measurements, however, significant isolation from the environment—be it laser stabilization or cooling—is often required, which might hinder portability or rugged field deployment realizations.

Superconducting gravimeters typically have low thermodynamical noise and low-drift, which can be due to the inherent stability of persistent currents in the superconductor, stability of the mechanical proof mass (e.g., a few grams), and insensitivity to ambient perturbations. Superconducting gravimeters, however, typically operate at cryogenic temperatures at ˜4.2K or lower the even in a closed-cycle cryostat requires ˜1 kW power for helium liquefaction, bringing challenges outside the laboratory environment.

The third class of gravimeters provides the spring-type approach for relative inertial force measurements. This approach is generally the most deployed. Prior work in the bulk involved simply an inclined spring to a cantilever beam (e.g., 10 cm spring) that gives a ˜100 nm displacement for a ˜10 ng relative gravity difference. This displacement can be sensed optically. The ensuing linearity about the zero-displacement point can provide a large measurement range; the use of quartz beams can alleviate concerns such as, e.g., hysteresis and fatigue in the sensor. This baseline design has been continuously modified and updated by, for example, Scintrex and sister company Micro-g La Coste, encompassing applications such as, e.g., mapping the deep ocean seafloor morphologies. In one particular implementation, the recent gPhone can achieve, for example, 100 nGal resolution, 1 μGal precision with a system noise of 3 μGal/Hz^{1/2}, 7 Gal range and 1.5 mGal/month drift. This bulk unit can also include a rubidium clock to synchronize the global positioning system. A compact chip-scale gravimeter, however, till date only has a few initial recent suggestions, involving, for example, gravimeters with capacitative readout.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and devices particularly pointed out in the written description and claims thereof, as well as from the appended drawings.

An apparatus is provided for measuring gravitational force including at least one optomechanical oscillator, the at least one optomechanical oscillator having an initial resonance, and a second resonance when displaced by gravitational force; and at least one photonic crystal having at least one cavity coupling optical and mechanical degrees of freedom of the oscillator.

In some embodiments, at least one radiation source arrangement directs at least one first radiation towards the at least one optomechanical oscillator.

In some embodiments, at least one detecting arrangement at least one of receives or detects at least one second radiation from the at least one optomechanical oscillator.

In some embodiments, at least one hardware processing arrangement determines the shift in the resonance associated with the at least one optomechanical oscillator based on the first and second radiations.

In some embodiments, at least one hardware processing arrangement further determines the gravitational force based on the shift in the resonance.

In some embodiments, at least one optomechanical cavity includes at least one slot, and wherein the shift is a function of a width of the at least one slot.

In some embodiments, at least one optomechanical cavity includes a high Q/V air-slot photonic crystal mode gap cavity

In some embodiments, the apparatus is on the scale of less than 5 millimeters.

In some embodiments, a mass suspended by one or more tethers, wherein the mass is less than 1000 ng.

A method for measuring gravitational force or field is provided which includes providing at least one first radiation to at least one optomechanical oscillator, the at least one optomechanical oscillator having an initial resonance, and a second resonance when displace by gravitational force; receiving at least one second radiation from the at least one optomechanical oscillator, wherein the at least one second radiation is associated with the second resonance; and determining a shift in the resonance of the optomechanical oscillator based on the first and second radiations; and determining a gravitational force or field.

In some embodiments, the method further includes providing the optomechanical oscillator having at least one optomechanical cavity including at least one slot, and wherein the shift is a function of a width of the at least one slot.

In some embodiments, the method further includes providing the at least one optomechanical cavity with a high Q/V air-slot photonic crystal mode gap cavity.

A non-transitory computer readable medium for determining a shift in a resonance associated with at least one optomechanical oscillator is provided including instructions thereon that are accessible by a hardware processing arrangement, wherein, when the processing arrangement executes the instructions, the processing arrangement is configured to perform at least one procedure including directing at least one first radiation to the at least one optomechanical oscillator which is structured to deform under a gravitational force so as to cause a shift in a resonance associated with the at least one optomechanical oscillator; receiving at least one second radiation from the at least one optomechanical oscillator, wherein the at least one second radiation is associated with the shifted resonance; and determining the shift in the resonance associated with the at least one optomechanical oscillator based on the first and second radiations.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and device of the disclosed subject matter. Together with the description, the drawings serve to explain the principles of the disclosed subject matter.

### BRIEF DESCRIPTION OF THE DRAWINGS

FIG. 1 is a representation of an exemplary embodiment in accordance with the disclosed subject matter.

FIG. 2 is an enlarged view of the portion denoted “2” in dashed line in FIG. 1 in accordance with the disclosed subject matter.

FIG. 3 is an enlarged view of the portion denoted “3” in dashed line in FIG. 2 in accordance with the disclosed subject matter.

FIG. 4 is an enlarged view of the portion denoted “4” in dashed line in FIG. 2 in accordance with the disclosed subject matter.

FIG. 5 is a representation of an exemplary embodiment in accordance with the disclosed subject matter.

FIG. 6 is an enlarged view of the portion denoted “6” in dashed line in FIG. 5 in accordance with the disclosed subject matter.

FIG. 7 is an enlarged view of the portion denoted “7” in dashed line in FIG. 5 in accordance with the disclosed subject matter.

FIG. 8 is a representation of an exemplary embodiment in accordance with the disclosed subject matter. FIG. 8 illustrates an exemplary chip-scale oscillator for optomechanical gravimetry, e.g., a scanning electron micrograph (SEM) of the mode-gap air-slot cavities. Scale bar (lower right) represents 400 nm.

FIG. 9 is an enlarged view of the portion denoted “9” in dashed line in FIG. 8 in accordance with the disclosed subject matter. FIG. 9 illustrates the displaced holes to create the localized cavity resonances, with differential shift of d_{A}=14 nm, d_{B}=9 nm, and d_{C}=5 nm. Scale bar (lower right) represents 400 nm.

FIG. 10 represents measured resonances through collected radiation in accordance with the disclosed subject matter.

FIGS. 11(a)-(f) illustrate exemplary optical cavity modes of mode-gap air-slot cavity from finite-difference time domain and band structure calculations. FIGS. 11(a)-(c) illustrate |E|² spatial distribution of first three modes. FIGS. 11(d)-(f) illustrate corresponding first three slot photonic crystal waveguide modes, with H_{z} (left) and |E|² (right) distributions illustrated from band structure calculations.

FIG. 12 illustrates a further exemplary embodiment in accordance with the disclosed subject matter.

FIG. 13 is a block diagram illustrating an exemplary measurement set up for phase-shift detection of the exemplary device, e.g., maintained in the “isolation enclosure,” in accordance with the disclosed subject matter. The exemplary set up implements Mach-Zehnder fiber interferometer. The EOM phase-shifter facilitates measurement calibration.

FIGS. 14-15 illustrate an exemplary cryostat chamber for use with the exemplary device.

FIG. 16 illustrates a further experimental setup for use with the exemplary device in accordance with the disclosed subject matter.

FIG. 17 illustrates an exemplary flow diagram of an exemplary procedure in accordance with the disclosed subject matter.

FIG. 18 illustrates an exemplary block diagram of an exemplary system in accordance with the disclosed subject matter.

FIGS. 19-22 illustrate exemplary displacement sensitivity for the exemplary device in accordance with the disclosed subject matter.

FIGS. 23-26 illustrate the effect of a vacuum on the quality factor of the exemplary device in accordance with the disclosed subject matter.

### DETAILED DESCRIPTION OF THE DISCLOSED SUBJECT MATTER

Reference will now be made in detail to various embodiments of the disclosed subject matter, an example of which is illustrated in the accompanying drawings. The method and corresponding steps of the disclosed subject matter will be described in conjunction with the detailed description of the device.

Exemplary embodiments of the present disclosure can provide a chip-scale high-performance gravimeter through cavity optomechanics and methods for using the same. Exemplary embodiments of the present disclosure can provide, for example, a compact and array scalable optical readout gravimeter, with, for example, 10 μGal/Hz^{1/2} (or ˜10 ng/Hz^{1/2}) noise levels at 20 mHz sampling rates, and methods for using the same. The cavity optomechanical measurement sensitivity (up to ˜5×10⁻¹⁷ m/Hz^{1/2}) can benefit, for example, from the low amplitude and phase noise of coherent laser sources. This exemplary approach can extend, for example, prior work on cavity optomechanics, such as, e.g., photonic crystal based slot-cavities for laser cooling of mesoscopic states, and nonclassical phase control of photon states through coupled cavity optomechanical nodes.

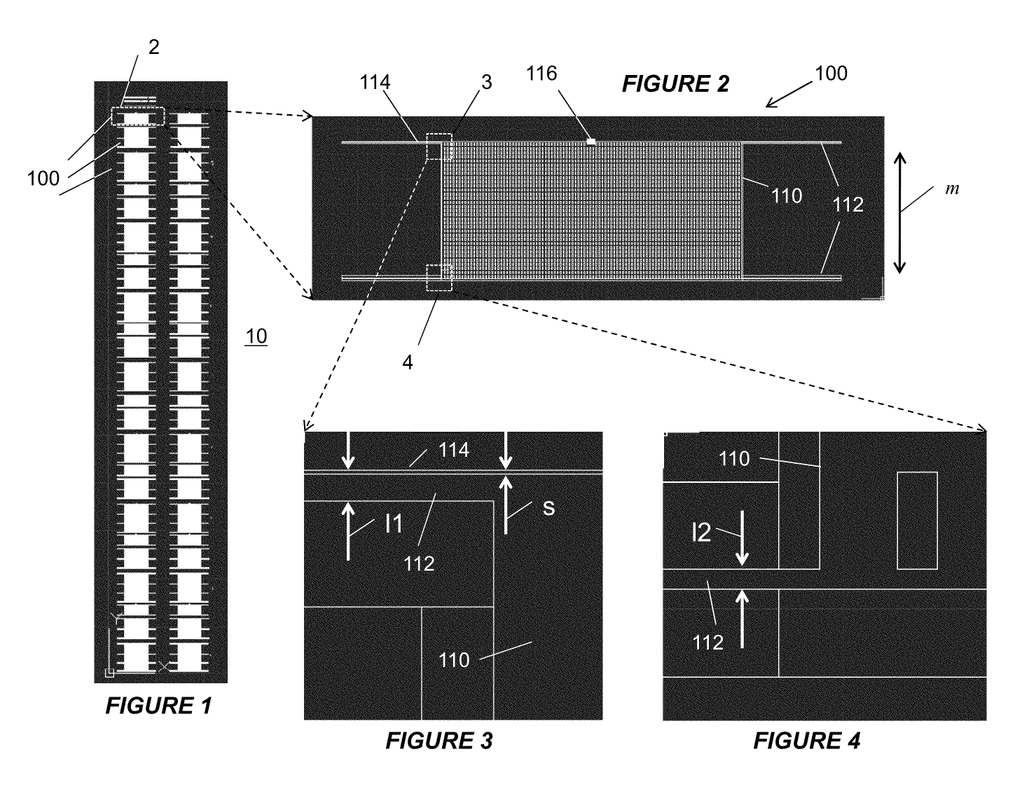

Exemplary embodiments of the present disclosure are illustrated in FIGS. 1-12. The exemplary embodiments detect gravity fluctuations and use shifts in optomechanical resonance as a transduction method. A photonic crystal waveguide is microfabricated as a split structure consisting of a suspended beam and a fixed beam. Light is then directed into the waveguide and the force of the electromagnetic field displaces one beam relative to the other. For a particular beam geometry and frequency of light, the beam will start to oscillate.

Under the principle of transduction, the intensity of the light transmitted by the waveguide will vary as the beam is displaced by different amounts. Changing gravitational forces will alter the amount one of the beams deflects (and its resonant frequency.) The transmission of the waveguide can be measured. The device has multiple modes so a second mode can probe the device to detect the resonance shift.

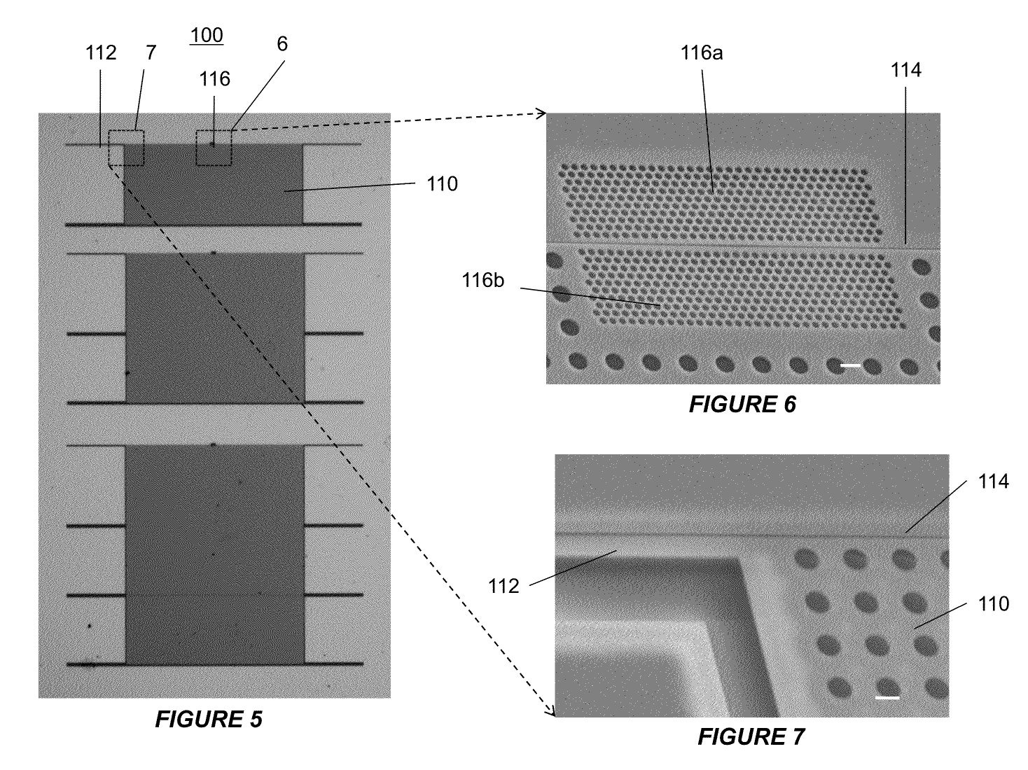

As illustrated in FIGS. 1-3, an exemplary embodiment of the subject matter includes chip 10 in which a plurality of gravimeters 100 have been fabricated. In some embodiments, gravimeter 100 is “chip-scale,” e.g., less than 5 mm, or less than 10 mm square in size. Chips 10 can be manufactured, e.g., using CMOS technology and electrobeam lithography. As illustrated in greater detail in FIG. 2, gravimeter 100 includes a mass 110 suspended by several nano-tethers 112. The mass 110 displaces in the direction denoted “m” in FIG. 2 under the force of gravitation. In some embodiments, the arm width 11/12 is about 1000 nm. The photonic crystal waveguide or optomechanical oscillator 116 is fabricated in the chip 10 in two components, as seen more clearly in FIGS. 5-6. For example, FIG. 6 illustrates a first portion 116a that is fixed and a second portion 116b that is suspended. Air slot 114 extends between the first portion 116a and the second portion 116b of the oscillator 116. In some embodiments, the slot s has a dimension of about 60 nm to about 110 nm. For example, exemplary slot dimensions include 63.8 nm, 105 nm, etc. The suspended mass is about 700 ng to about 800 ng, e.g., 745.6 ng, 750 ng, etc. Further exemplary specifications are provided in Table 1 and Table 2.

Exemplary performance characteristics are provided herein:

TABLE 1

| | Device A | Device B | Device C |
|---|---|---|---|
| gravimeter beam length | 8.6 mm | 4.3 mm | 2 mm |
| beam width (mass width) | 1 μm (9.7 mm) | 1 μm (5 mm) | 1 μm (500 μm) |
| standard Δg sensitivity | 10-100 ng | 0.1-1 μg | 1-10 μg |
| regime | | | |

TABLE 2
Chip-scale optomechanical gravimeter: device C
2 mm beam length; 1 μm beam width (500 μm mass width);
320 nm thickness; slot width (s): 67.65 nm; silicon or silicon nitride
Physical properties

| | | | | g_{OM} | | | |
|---|---|---|---|---|---|---|---|
| Qₒ | λ (nm) | Ω (Hz) | Qₘ | (Hz/m) | m_eff | M | k (N/m) |
| 100,000 | 1550 nm | 10,000 | 1 | 9.80 × | 745 ng | 750 ng | 6.7 × 1 |
| | | | | 1020 | | | |

Measurement parameters
laser power at 260 μW
base temperature at 200 K

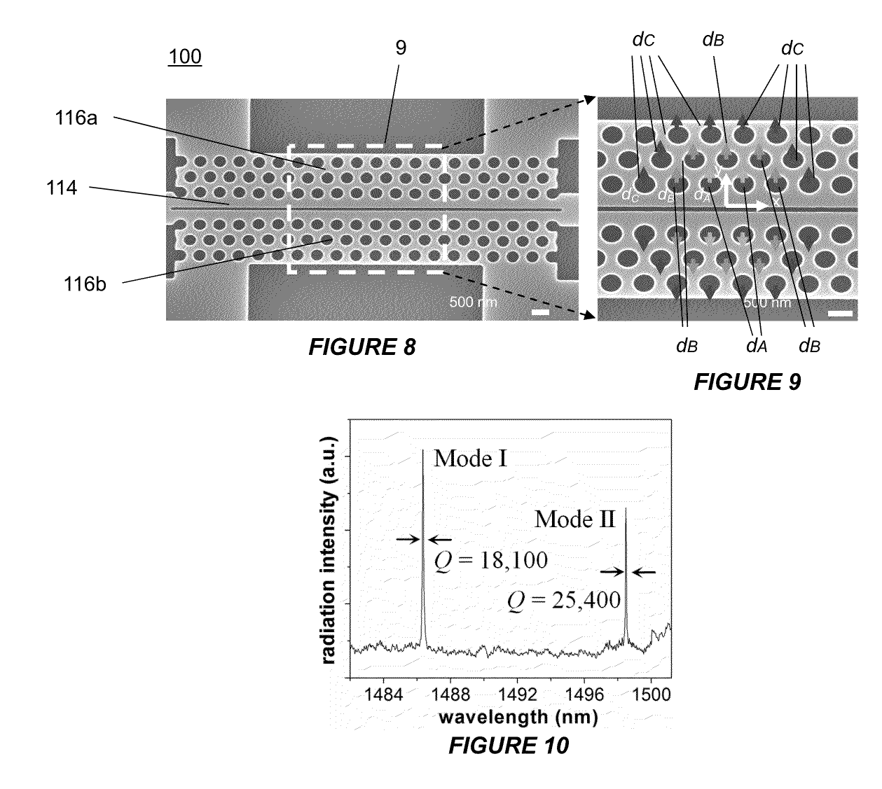

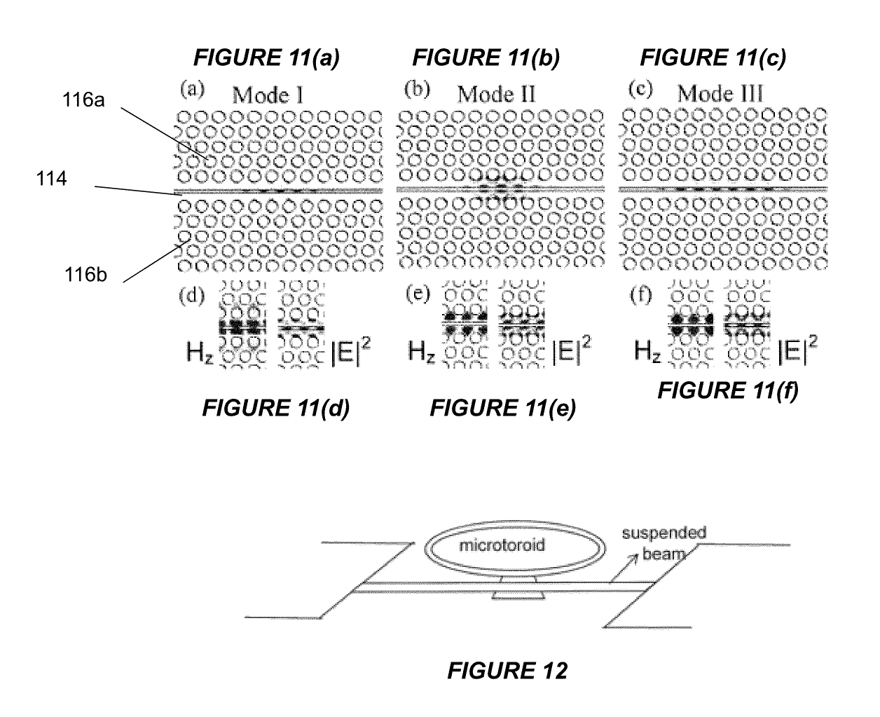

In some embodiments, the gravimeter is a chip-scale gravimeter that can be based on, for example, the high-Q/V air-slot photonic crystal mode gap cavity examined for cavity optomechanics. As illustrated in FIGS. 8-9, an exemplary optomechanical oscillator can have a loaded optical Q in excess of 10⁴ measured (10⁶ theory) while preserving, for example, a deeply-subwavelength optical modal volume V of ˜0.02(λ/n)³. The gravitational force can serve to displace (δx) the optomechanical oscillator position. The nanobeams can be provided for a mode displacement that is either common or differential (e.g., such that one nanobeam can be much more compliant than the other)—both of which can result in a perturbation to the optical cavity resonance. For a 100 pg silicon (or silicon nitride) optomechanical cavity with 50 kHz fundamental mechanical mode resonance, e.g., an approximate 4 nm displacement can be observed under 1 g acceleration. These displacements are typically in the first-order perturbative regime for the optical resonance. The resonance shift can depend linearly on the spacing of air-slot 114 spacing (denoted as spacing s in FIG. 3) at a rate, for example, of ˜−0.88 nm wavelength shift per nm of the mechanical oscillator displacement (or equivalently ˜3.5 nm wavelength shift for a differential 1 g acceleration). The perturbed optical resonance can be detected through the second mode (II) of the cavity (FIGS. 10 and 11), measuring the differential transmitted intensity.

### Exemplary Noise Considerations

The mechanical oscillator displacement sensitivity in high-Q/V systems such as the disclosed subject matter can be remarkable, with an experimentally-observed minimal photoreceiver-noise-limited sensitivity of, for example, ˜5×10⁻¹⁷ m/Hz^{1/2}, or about four times the standard quantum limit. In a homodyne detection, the theoretical shot-noise-limited displacement sensitivity of the cavity optomechanical system can be described by the following equation:

$$δ {x}_{min} ≅ \frac{λ}{8 π Q \sqrt{η P / ℏ ω}}$$

For the exemplary cavity Q of ˜40,000, P at 1 μW and scaling coefficient η of 0.5, the displacement sensitivity can reach ˜8×10⁻¹⁹ m/Hz^{1/2} theoretically, which can be even feasible for zero-point motion detection with a 1 kHz resolution bandwidth, if the readout laser has quantum limited amplitude and phase noise.

The practical noise contributions can arise, for example, from thermal Brownian noise, photoreceiver (detector) noise, optical shot noise, and quantum backaction noise from optical gradient force fluctuations.

The thermal Brownian motion can be represented as follows:

$${S}_{xx}^{th} ( Ω ) = \frac{4 {k}_{B} T {m}_{x} {Ω}_{M}}{{Q}_{M}} {χ}_{M}^{2} ( Ω )$$

$${\vert χ ( Ω ) \vert}^{2} = \frac{1}{{m}_{eff}^{2} ( {( {Ω}_{m}^{2} - {Ω}^{2} )}^{2} + {Γ}_{m}^{2} {Ω}^{2} )}$$

The optical shot noise comes from noise in the light field at the output. The noise spectrum contains all the information on the mechanical displacement spectrum, but also a background term that is due to the quantum noise. This background constitutes the imprecision of the measurement. The optical shot noise is represented as follows:

$${S}_{xx}^{SN} ( {Ω}_{M} ) = ( \frac{2 h {ω}_{0}^{3} ( \frac{{( 1 + K )}^{2}}{3 K} - 1 )}{3 {ηg}_{OM}^{2} {Q}^{2}} ) {P}_{d}^{- 1}$$

The detector noise can be represented as follows:

$${S}_{xx}^{PD} ( {Ω}_{M} ) = ( \frac{2 {ω}_{0}^{2}}{3 {g}_{OM}^{2} {Q}^{2}} ) {( \frac{NEP}{{P}_{d}} )}^{2}$$

The measurement of the oscillator's position disturbs. In the case of an optomechanical system, this is due to the fluctuation of intracavity radiation pressure. The force noise is referred to as quantum backaction noise, and is represented as follows:

$${S}_{xx}^{BA} ( Ω ) = 6 h {g}_{OM}^{2} \frac{K {Q}^{2}}{{ω}_{0}^{3}} {χ}_{M}^{2} ( Ω ) {P}_{d}$$

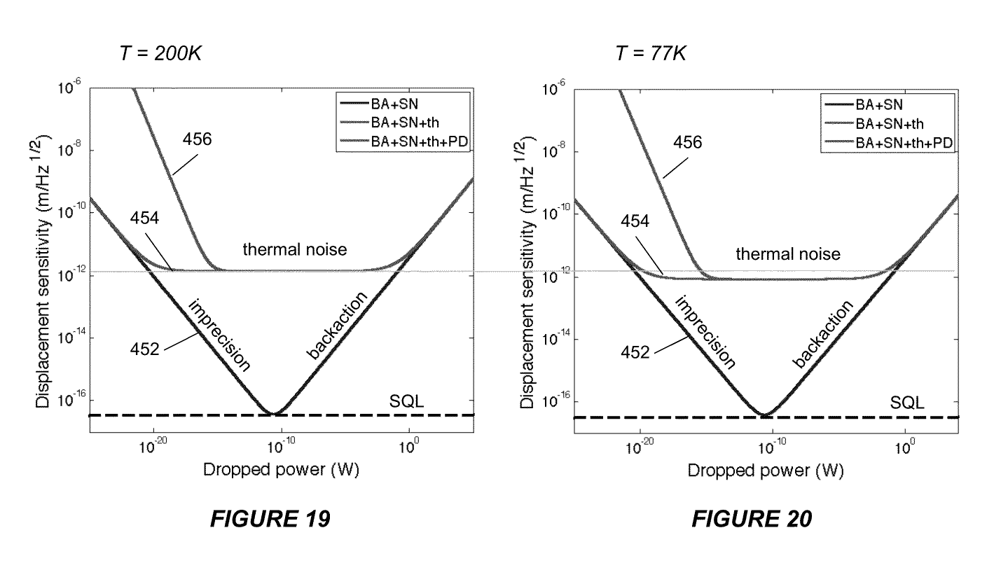

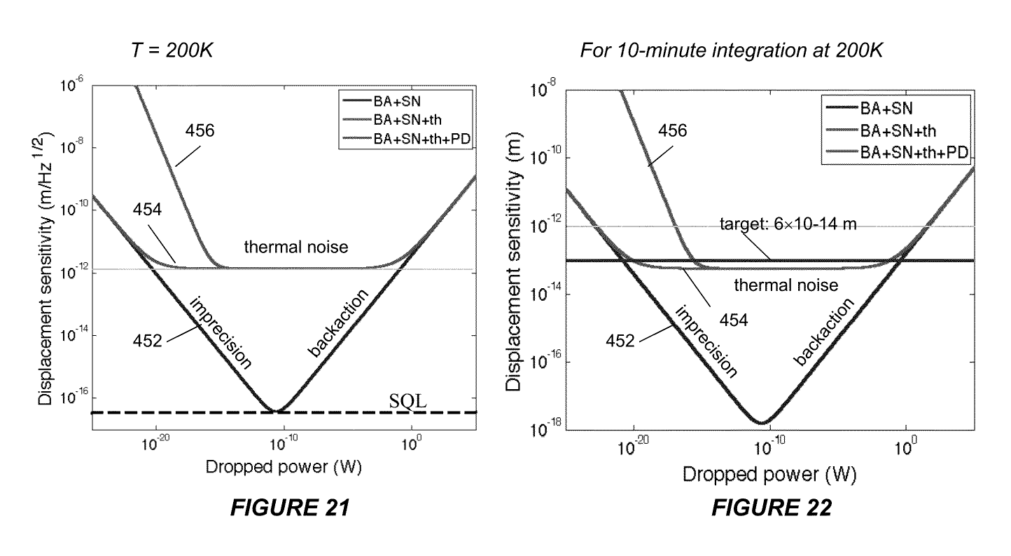

Balanced homodyne phase-sensitivity measurement is described. Displacement sensitivity for the exemplary gravimeter design is illustrated in FIGS. 19-22. Backaction noise (BA)+shot noise (SN)+thermal noise (th)+photodetector noise (PD). (In the Figures, Backaction noise (BA)+shot noise (SN) is illustrated as line 452. BA+SN+th is illustrated as line 454. BA+SN+PD is illustrated as line 456.) The Black dashed line is standard quantum limit (SQL) in the exemplary design. For a 2 mm length device to get a 1 μg gravity change resolution, a displacement sensitivity lower than 6×10⁻¹⁴ m is needed, as illustrated in FIG. 22. A 280 kHz measurement bandwidth or 4.6 minutes integration can achieve this, at 200K or room temperature. (To achieve 10 ng, the device is designed for 8.6 mm length.)

Since the device and systems described herein detect the transmission of light, the RF spectrum shows us the noise power-spectral-density (PSD) directly, which arise from the contribution of the thermal Brownian noise, photoreceiver (detector) noise, optical shot noise, and quantum backaction noise. With

$${P}_{m} ( ω ) = \frac{d T}{d Δ} {η}_{in} {P}_{in} {g}_{OM} x ( ω )$$

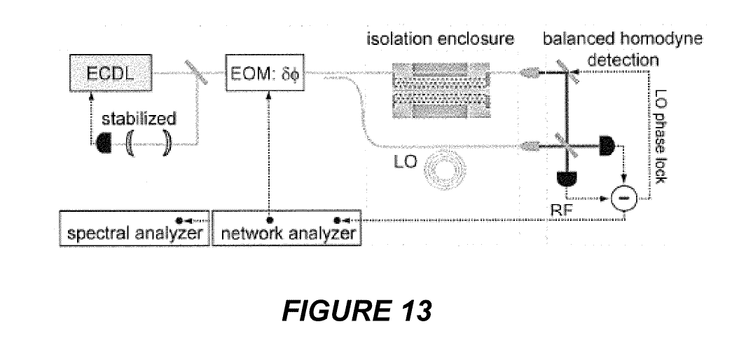

Exemplary embodiments of the present disclosure can also facilitate Pound-Drever-Hall locking and detection—this phase sensitive detection technique can allow a direct measurement of nanomechanical position (see example measurement setup in FIGS. 13).

This can facilitate the characterization of the displacement noise spectrum and the thermal Brownian motion [given, e.g., as 2k_{B}Tₛₑₙₛₑ/m_{eff}ΩₘΓₘ where Tₛₑₙₛₑ can be the effective temperature of the sensing (e.g., fundamental) mechanical mode, m_{eff} can be the effective mass of the mechanical mode, Ωₘ can be the resonance frequency, and Γₘ can be the mode decay rate] of the chip-scale optomechanical gravimeter.

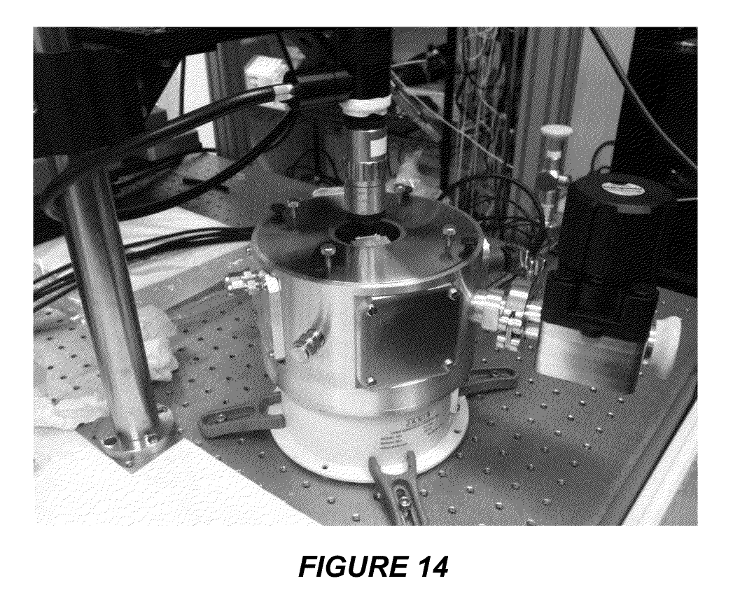

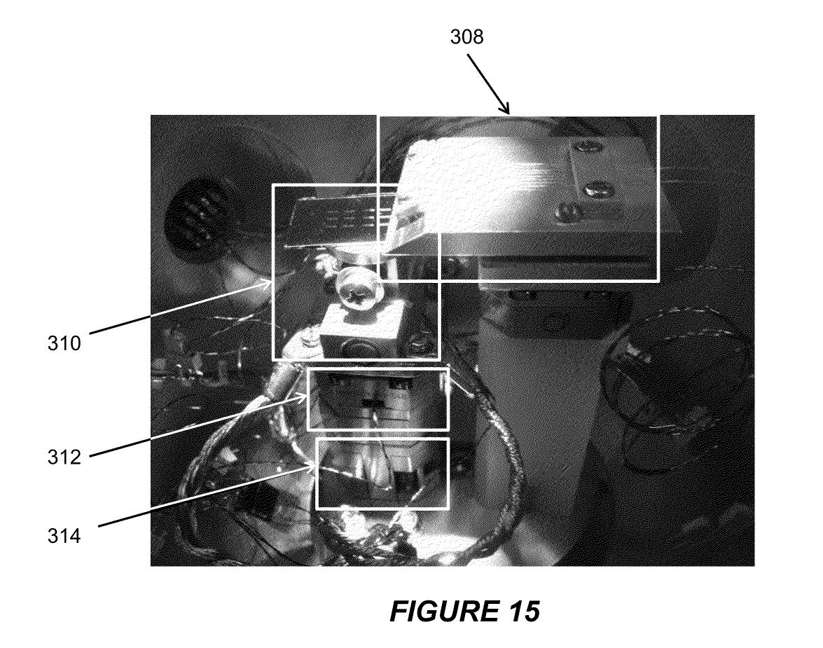

FIGS. 14-15 illustrate a cryostat chamber which operates at a high vacuum, e.g., about 10⁷ Torr and at low temperatures, e.g., about 10K. FIG. 15 illustrates the components of the setup, which include fiber holder 308, sample holder 310 for supporting the device 10, scanner 312 applying sinusoidal acceleration, and positioner fiber coupling 314.

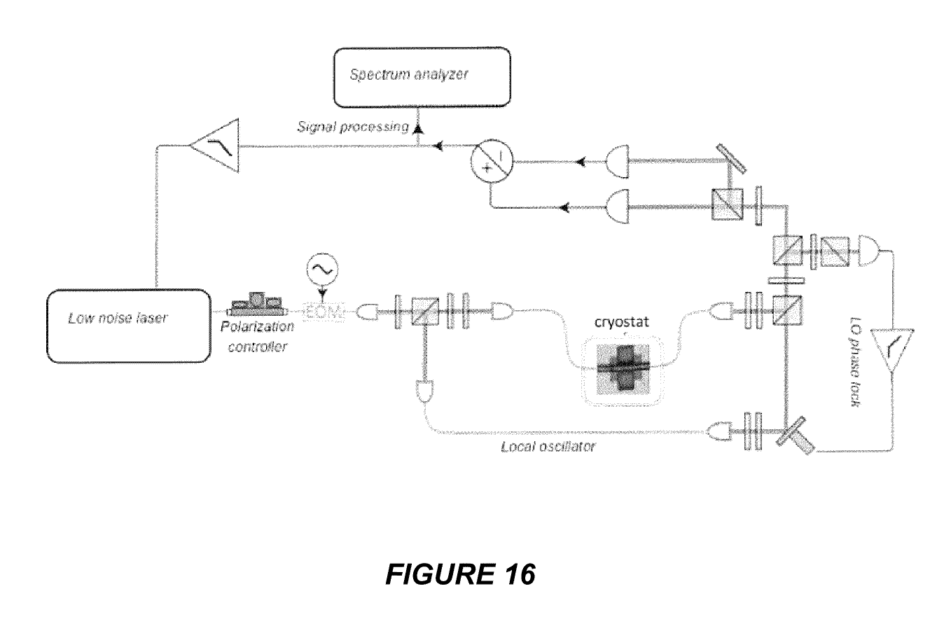

FIG. 16 illustrates a set up for quantum-limited phase measurement. The signal beam and a phase reference beam are derived from the same laser. A probing beam is sent through a coupling taper and interacts with the photonic crystal cavity. The LO travels in the reference arm of a Mach-Zehnder interferometer over the same distance. It is finally recombined with the signal beam at a polarizing beam splitter. Spatial mode matching of the incident beams is enhanced by using single-mode fiber as mode filter on the local oscillator. After spatial recombination, interference is enforced using a retarder plate and another polarizing beam splitter. The laser source can preferably exhibit quantum-limited amplitude and phase noise at Fourier frequency ≧10 KHz and power level ≦1 mW.

Exemplary Resonant detection: It is likely that a resonantly-driven measurement provide a better signal-to-noise to achieve the 10⁻⁸ sensitivities desired for the gravimeter. In the present case, the optical gradient force can drive the exemplary system on its RF mechanical resonance Ωₘ. The optical gradient force can arise from, for example, the evanescent optical fields and can be calculated through the Maxwell stress tensor and first-order perturbation theory. The optical force can give rise to an optical stiffening of the RF resonance, a resonance shift (Ω′ₘ−Ωₘ) that can depend on the gravity-induced slot displacement as described by

$${Ω}_{m}^{′2} = {Ω}_{m}^{2} + ( \frac{2 {\vert {a}_{o} \vert}^{2} {g}_{om}^{2} ( δ x )}{{Δ}^{2} {ω}_{o} {m}_{x}} ) {Δ}_{o}^{′} ,$$

where the optical interaction rate gₒₘ can be dependent on the gravity-induced slot displacement δx, |aₒ|² can be the time-averaged Δ′ₒ the laser-cavity detuning, and Δ²=Δ′ₒ²+(Γ₀/2)² with Γ₀ the optical cavity photon decay rate. For a fixed laser-optical resonance detuning, the input laser power can be swept; the resulting characteristic slope of the mechanical frequency optical stiffening can differ for varying gravitational forces.

The high transduction sensitivity can benefit from the low amplitude and phase noise of coherent laser sources, in addition to the resonant driving approach. Further, resonant nanomechanical oscillators—by going to higher frequencies—can facilitate mass sensing in the range of attograms to zeptograms (10⁻²¹ grams), equivalent to the inertia force of several xenon atoms or an individual kDa molecule. The frequency shift can be read out electrically. This differential inertia force sensitivity can range ˜from 1 part in 10⁵ to 1 part in 10¹², very promising to reach 10⁻⁸ sensitivities desired in this gravimeter implementation. With the two-available optical cavity modes and wavelength-division multiplexing, a combined drive-and-sense protocol can also be implemented in the chip-scale optical gravimeter for compactness, noise normalization and robustness.

Exemplary Measurement considerations: The physical measurements and device nanofabrication can be examined, along with approaches to suppress the primarily noise sources. For field deployment, commercially available vertical cavity surface emitting lasers with low relative intensity noise can be embedded. The exemplary chip gravimeter can be packaged in vacuum that can facilitate the resonant mass to be kept constant to avoid, for example, spurious frequency shifts, to attain a high quality factor mechanical resonance, and to avoid molecular dynamical noise. The exemplary sensor can also be placed in vibration-isolated mounts (such as, e.g., from Minus-K) so as to suppress seismic noise. With an exemplary sampling rate in the range of 20 mHz and the tens to hundreds kHz resonances, e.g., a large sampling to average down the noise fluctuations can be feasible, although long-term (e.g., in the period of days) drift corrections are preferably carefully considered. A referencing between two (or more) gravimeters on the same chip should normalize out much of the seismic noise, while facilitating more rapid data acquisition. Readout noise and resonant dynamic range can be examined, from nonlinear optical stiffening at the high end (e.g., to avoid nonlinear Duffing instability), to source and detector shot noise at the low end. Thermoelectric cooling of the chip can also be examined for possible noise reductions. For exemplary absolute measurements, the exemplary chip-scale gravimeter can also be calibrated at a known-gravity site or with a laser-interferometer absolute gravimeter, although calibration variability are preferably carefully examined. The chip-scale implementation can also provide arrayed capability, such as for tensor gradiometer and parallel multiple measurements for improved noise averaging and multi-modal functionality in the same compact package.

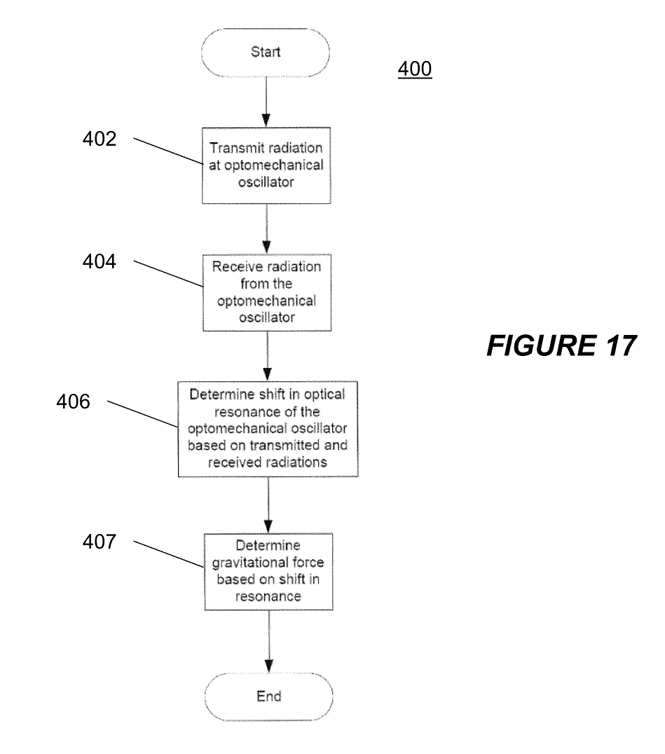

FIG. 17 shows an exemplary flow diagram of an exemplary procedure 400 according to an exemplary embodiment of the present disclosure. For example, as shown in FIG. 17, a radiation (e.g., a nanobeam) can be directed at an optomechanical oscillator, such as one described above (procedure 402). Next, a resulting radiation from the optomechanical oscillator can be received (procedure 404), and a shift in the resonance of the optomechanical oscillator can be determined (procedure 406). This shift in the resonance of the optomechanical oscillator can be used to determine a gravitational force or field (procedure 408).

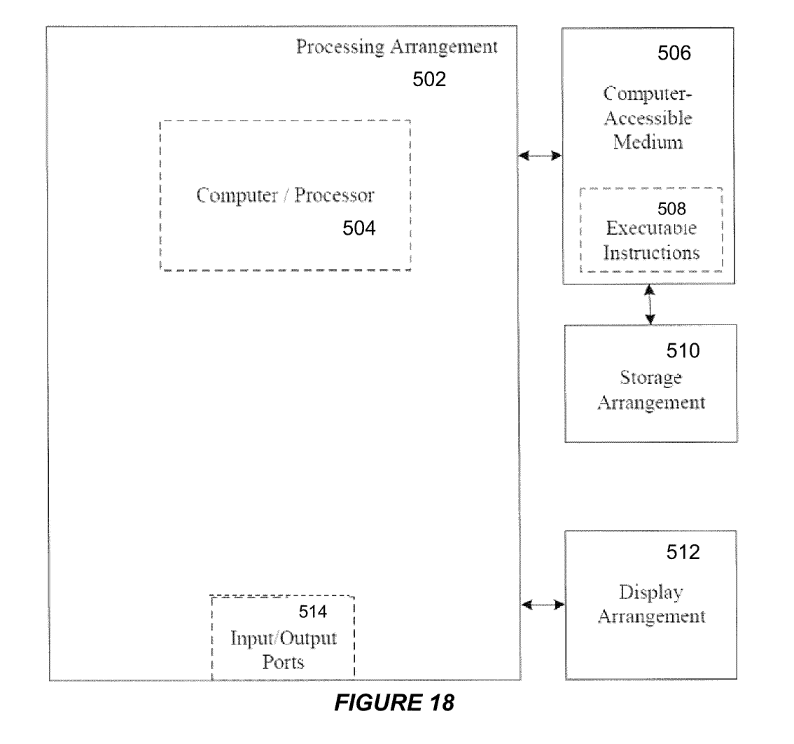

FIG. 18 shows an exemplary block diagram of an exemplary embodiment of a system according to the present disclosure. For example, exemplary procedures in accordance with the present disclosure described herein can be performed by a processing arrangement and/or a computing arrangement 502. Such processing/computing arrangement 102 can be, e.g., entirely or a part of, or include, but not limited to, a computer/processor 504 that can include, e.g., one or more microprocessors, and use instructions stored on a computer-accessible medium (e.g., RAM, ROM, hard drive, or other storage device).

As shown in FIG. 18, e.g., a computer-accessible medium 506 (e.g., as described herein above, a storage device such as a hard disk, floppy disk, memory stick, CD-ROM, RAM, ROM, etc., or a collection thereof) can be provided (e.g., in communication with the processing arrangement 502). The computer-accessible medium 506 can contain executable instructions 508 thereon. In addition or alternatively, a storage arrangement 510 can be provided separately from the computer-accessible medium 506, which can provide the instructions to the processing arrangement 502 so as to configure the processing arrangement to execute certain exemplary procedures, processes and methods, as described herein above, for example. The exemplary instructions and/or procedures can be used for determining a shift in a resonance associated with at least one optomechanical oscillator based on, e.g., the exemplary procedure described herein and associated with the exemplary embodiment of FIG. 17.

Further, the exemplary processing arrangement 502 can be provided with or include an input/output arrangement 514, which can include, e.g., a wired network, a wireless network, the internet, an intranet, a data collection probe, a sensor, etc. As shown in FIG. 18, the exemplary processing arrangement 502 can be in communication with an exemplary display arrangement 512, which, according to certain exemplary embodiments of the present disclosure, can be a touch-screen configured for inputting information to the processing arrangement in addition to outputting information from the processing arrangement, for example. Further, the exemplary display 512 and/or a storage arrangement 510 can be used to display and/or store data in a user accessible format and/or user-readable format.

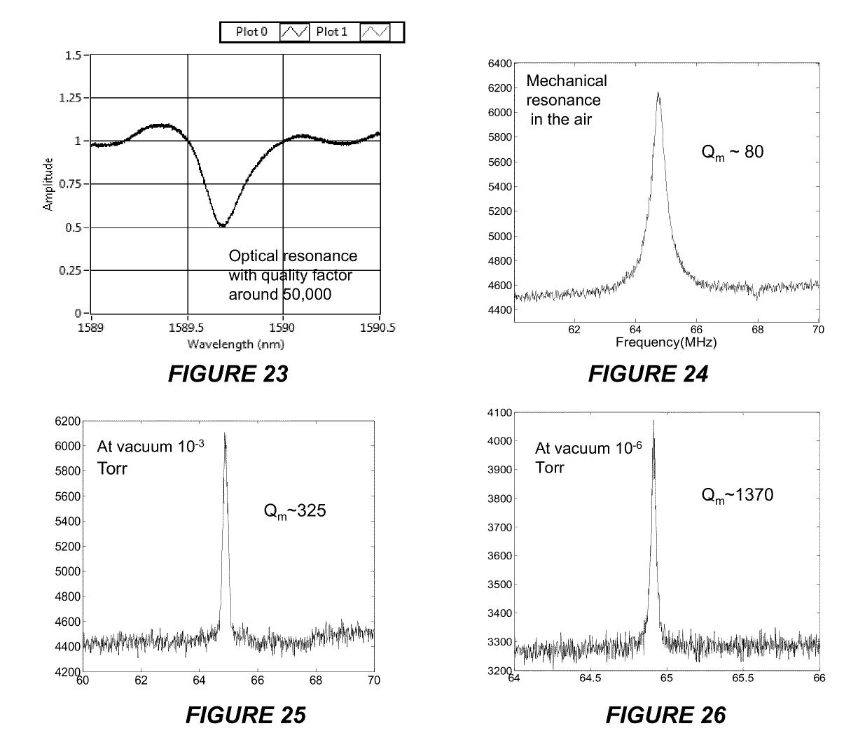

FIGS. 23-26 illustrate improvements in mechanical quality factor which occur in vacuum, e.g., 10⁻⁶ mbar vacuum, in which the mechanical quality factor was improved 20 times.

FIG. 24 illustrates the mechanical resonance in the air (Qm ˜80). FIG. 25 illustrates the mechanical resonance at vacuum of 10⁻³ Torr (Qm ˜325), and FIG. 26 illustrates the mechanical resonance at a vacuum of 10⁻⁶ Ton (Qm ˜1370).

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. An apparatus for measuring gravitational force comprising:
at least one optomechanical oscillator, the at least one optomechanical oscillator having an initial resonance, and a second resonance when displaced by gravitational force; and
at least one photonic crystal having at least one cavity coupling optical and mechanical degrees of freedom of the oscillator.

2. The apparatus of claim 1, further comprising at least one radiation source arrangement to direct at least one first radiation towards the at least one optomechanical oscillator.

3. The apparatus of claim 2, further comprising at least one detecting arrangement to at least one of receive or detect at least one second radiation from the at least one at least one optomechanical oscillator.

4. The apparatus of claim 3, further comprising at least one hardware processing arrangement to determine the shift in the resonance associated with the at least one optomechanical oscillator based on the first and second radiations.

5. The apparatus of claim 4, wherein the at least one hardware processing arrangement is further to determine the gravitational force based on the shift in the resonance.

6. The apparatus of claim 1, wherein the at least one optomechanical cavity includes at least one slot, and wherein the shift is a function of a width of the at least one slot.

7. The apparatus of claim 6, wherein the at least one optomechanical cavity includes a high Q/V air-slot photonic crystal mode gap cavity

8. The apparatus of claim 1, wherein the apparatus is on the scale of less than 5 millimeters.

9. The apparatus of claim 1, further comprising a mass suspended by one or more tethers, wherein the mass is less than 1000 ng.

10. A method for measuring gravitational force or field, comprising:
providing at least one first radiation to at least one optomechanical oscillator, the at least one optomechanical oscillator having an initial resonance, and a second resonance when displace by gravitational force;
receiving at least one second radiation from the at least one optomechanical oscillator, wherein the at least one second radiation is associated with the second resonance; and
determining a shift in the resonance of the optomechanical oscillator based on the first and second radiations; and
determining a gravitational force or field.

11. The method of claim 10, further comprising providing the optomechanical oscillator having at least one optomechanical cavity including at least one slot, and wherein the shift is a function of a width of the at least one slot.

12. The method of claim 11, further comprising providing the at least one optomechanical cavity with a high Q/V air-slot photonic crystal mode gap cavity.

13. A non-transitory computer readable medium for determining a shift in a resonance associated with at least one optomechanical oscillator including instructions thereon that are accessible by a hardware processing arrangement, wherein, when the processing arrangement executes the instructions, the processing arrangement is configured to perform at least one procedure comprising:
directing at least one first radiation to the at least one optomechanical oscillator which is structured to deform under a gravitational force so as to cause a shift in a resonance associated with the at least one optomechanical oscillator.
